(19) United States
(12) Patent Application Publication
(10) Pub. No.: US 2006/0151045 A1
(43) Pub. Date: Jul. 13, 2006

(54) Horizontally produced large diameter spirally formed pipe

(76) Inventor: Scott Emery Johnston, Cottonwood, CA (US)

Correspondence Address: Scott E. Johnston, 16857 Hummingbird Lane, Cottonwood, CA, 96022, US

(21) Appl. No.: 11/374,563

(22) Filed: Mar. 14, 2006

Related U.S. Application Data
(63) Continuation-in-part of application No. 09/312,992, filed on May 17, 1999.

(51) Int. Cl. F16L 11/00

(52) U.S. Cl. 138/129

(57) ABSTRACT

A large diameter horizontally produced spirally formed pipe, having a diameter larger than similar pipe produced in the past, whereby said pipe will be available for use to manufacture products that have been traditionally produced by other means. This pipe is round or may be reshaped into an arch shape. As a round pipe the invention includes horizontally produced spirally formed pipes above 16 feet in diameter, and as a round pipe reshaped into an arch shape, the invention includes, horizontally produced spirally formed pipes above 16 feet in diameter before being reshaped into an arch shape.

### CROSS-REFERENCE TO RELATED APPLICATIONS

This application is a continuation-in-part of application Ser. No. 09/312,992 filed May 17, 1999.

### STATEMENT REGARDING FEDERALLY SPONSORED RESEARCH OR DEVELOPMENT

Not Applicable

### REFERENCE TO MICROFICHE APPENDIX

Not Applicable

### BACKGROUND OF THE INVENTION

This invention relates to horizontally produced spirally formed pipe and more particularly to larger sizes than have been produced in the past.

Horizontally produced spirally formed pipe has been in use for the past several decades. It has been used for a variety of purposes including; culverts, storm drains and pile pipes. Most often these pipes are used for round pipe products, but it is also reshaped into an arch shape for use where increased water flow in required. Due to the method of manufacture and shipping requirements, the size of these products has been limited to a maximum diameter of 12 feet and while many uses have been found for these products, it has not been considered for use in large diameter applications.

In the past, various large diameter round and arched shaped products were produced from bolted or welded together sections of material. The variety of uses included metal buildings, grain silos, water and gas storage tanks, underpasses, and culverts. While these products have been well accepted, they do require a crew of skilled workers, a large crane or lifting device for positioning panels, and considerable time to assemble.

During the examination of application Ser. No. 09/312,992, following the first appeal, several references pertaining to grain silo and storage tank manufacturing were presented utilizing an upright or vertical spiral fabrication process. Each of the references presented manufacturing techniques that would possibly improve upon production over the earlier bolted methods, however each of these systems would still require considerable labor and setup time. Additionally, these systems were only designed to manufacture vertically orientated silos and tanks. Application Ser. No. 09/312,992 utilized the term “spirally formed pipe” to describe the invention, the term was not considered descriptive enough to differentiate it from the vertically produced grain silo and storage tank references, making necessary this continuation-in-part application. The word “pipe” was determined to include the tank and silo references based on Webster's 10^{th} Collegiate Dictionary definition that pipe was simply “a tubular cylindrical object, part or passage”.

The horizontal spiral pipe manufacturing process generally consists of a roll forming machine in conjunction with a free forming three roll system. It is capable of producing a variety of sizes from the same width of material, by simply altering the helix angle and the positioning of the rollers in the three roll system. It is an automated process that requires only one operator to run, and only a few minutes to set up. Traditionally, horizontal manufacturing has been limited to factory production, however, a process was considered to bring the factory style horizontal spiral pipe manufacturing equipment near to the construction site to produce large diameter cylindrical homes. The round cylindrical shape has limited possibilities for building construction compared with the arched shape and has not been commercially accepted. The reference suggested sizes up to 15 feet in diameter could be produced, but the manufacturer only produced a 12 foot diameter prototype structure. Potentially, because the factory style machinery would need to be redesigned to produce sizes larger than 12 feet in diameter.

### BRIEF SUMMARY OF THE INVENTION

With the creation of a new “portable spiral pipe manufacturing machine”, U.S. Pat. No. 6,000,261 it is now possible to produce spirally formed pipes at the location where the pipes are used. The machinery has been modified to accept a variety of tooling, with special supporting apparatus to take full advantage of job site manufacturing, it is capable of producing very large diameter pipes. Additionally, with the creation of a new “large diameter arching machine”, U.S. Pat. No. 6,260,403 it is now possible to reshape large diameter pipe into an arch shape. This makes possible the use of large sized horizontally produced spirally formed pipes, for products that until now, have only been available in bolted or welded panel construction. In fact, with lock seam technology and deeper corrugation profiles it is possible to produce larger diameter sizes than any other pipe manufacturing technology. Pipes up to 100 foot in diameter or more are well within the range that this new equipment could be utilized to produce.

The invention is horizontally produced large diameter spirally formed pipe, round or reshaped into an arch shape, having a larger diameter than similar horizontally produced pipes of the past.

### BRIEF DESCRIPTION OF THE SEVERAL VIEWS OF THE DRAWING

FIG. 1 is a perspective view showing a variety of applications of large diameter horizontally produced spirally formed pipes.

FIG. 2 is a schematic representation of a portion of the horizontally produced spirally formed pipe product according to the invention.

FIG. 3 is an end view taken along lines 3-3 of FIG. 2 showing a round shape.

FIG. 4 is an end view taken along lines 4-4 of FIG. 2 showing an arch shape.

FIG. 5 is a sectional view taken along lines 5-5 of FIG. 2 showing pipe wall styles.

FIG. 6 is a sectional view taken along lines 5-5 of FIG. 2 showing welded seaming.

FIG. 7 is a sectional view taken along lines 5-5 of FIG. 2 showing welded lock seaming.

### DETAILED DESCRIPTION OF THE INVENTION

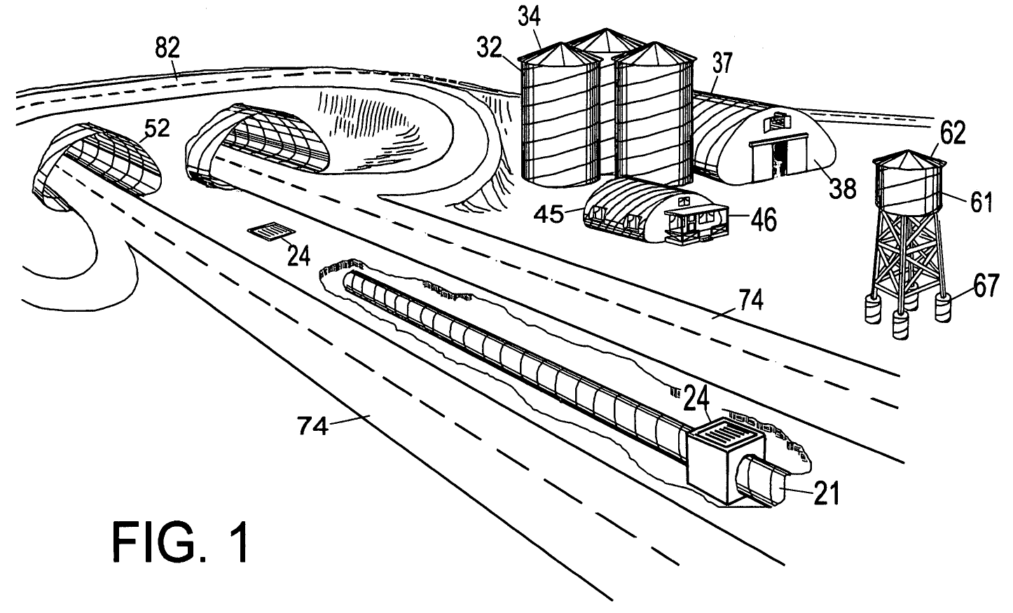

Referring now in detail to the drawings, the present invention horizontally produced large diameter spirally formed pipe has many uses as clearly shown in FIG. 1. A horizontally produced large diameter spirally formed pipe is reshaped into an arch shape and used as a highway overpass 52. A roadway 74 is paved through the lower portion of 52 while the cross street 82 is paved over the earth filled area above 52. A horizontally produced large diameter spirally formed pipe is reshaped into an arch shape and used as a barn or storage building 37, while the openings at either end are enclosed 38 with walls, doors and utility openings as needed. A horizontally produced large diameter spirally formed pipe is reshaped into an arch shape and used as a home 45, while the openings at either end are enclosed 46 with walls, doors, windows, and patios as needed. Both the home 45 and barn 37 may be used above ground, or could be installed below ground as overpass 52 illustrates. Horizontally Produced Large diameter spirally formed pipe may be placed vertically and used as a grain silo 32, with formed panels 34 to enclose the top and as a water storage tank 61, with formed panels 62 to enclose the top. These are several different embodiments of uses for horizontally produced large diameter spirally formed pipes as can be employed with the present invention and are merely illustrative of the various uses. Traditional uses such as highway storm drain 21 and pile pipe or shell 67 are well known uses for horizontally produced spirally formed pipe, while overpasses 52, storage buildings 37, homes 45, silos 32 and water tanks 61 being larger in diameter, have generally been produced from formed metal panels with bolted or welded construction.

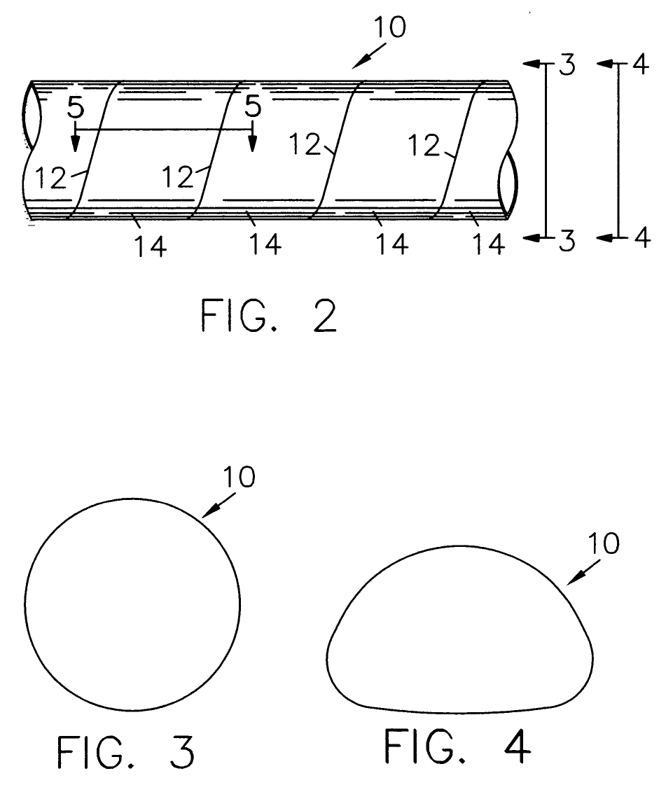

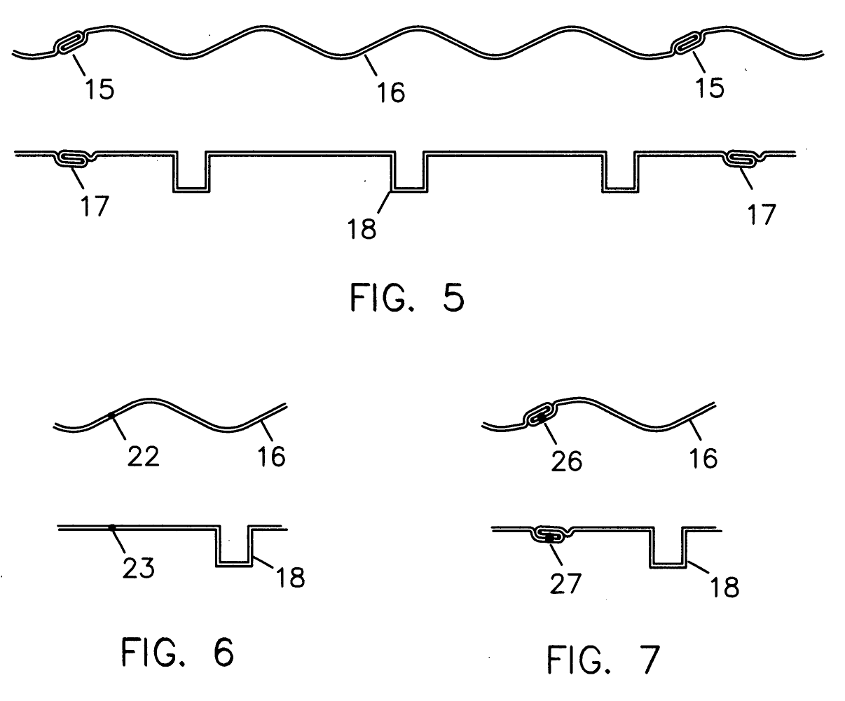

Referring now to FIG. 2, a pipe according to the invention is generally designated 10. The pipe is composed of an elongated strip of ductile material, such as galvanized steel, which is formed into adjacent, helical convolutions. As illustrated, convolutions 14 are joined at 12. Convolutions 14 form the wall of the pipe which may be corrugated or profiled. As the pipe diameter is increased the thickness of material and size of corrugation or profile is also increased. In other words, the dimensional proportions of the corrugated or profiled wall increases as pipe size is increased, this is to insure that the pipe gets stronger as the pipe is made larger. Section view FIG. 5. illustrates the variety of pipe wall styles. The corrugated wall 16 is joined by a conventional double lock seam 15, and the profiled wall 18 is joined by a conventional double lock seam 17. FIG. 6. illustrates welded seam construction. The corrugated wall 16 joined by a welded seam 22, and the profiled wall 18 is joined by a welded seam 23. FIG. 7. illustrates the welded lockseam construction. The corrugated wall 16 is joined by a welded lockseam 26, and the profiled wall 18 is joined by a welded lockseam 27.

The pipe 10 may be round as shown in FIG. 3 or reshaped into an arch shape as shown in FIG. 4. A pipe according to the invention is larger than 16 feet in diameter.

I claim:

1. A horizontally produced spirally formed pipe, comprising an elongated strip of ductile material formed into joined, adjacent helical convolutions, that said convolutions form the wall of said pipe, and that said wall is corrugated or profiled with increased dimensional proportions as pipe size is increased, and that said pipe has a diameter above 16 feet.

2. The pipe according to claim 1 further comprising that said joined adjacent helical convolutions includes lockseam joining of said ductile material.

3. The pipe according to claim 1 further comprising that said joined adjacent helical convolutions includes welded seam joining of said ductile material.

4. The pipe according to claim 1 further comprising that said joined adjacent helical convolutions includes welded lockseam joining of said ductile material.

5. The pipe according to claim 1 further comprising that said pipe is reshaped into an arch shape.

6. A horizontally produced spirally formed pipe, comprising an elongated strip of ductile material formed into joined, adjacent helical convolutions, that said convolutions form the wall of said pipe, and that said wall is corrugated or profiled with increased dimensional proportions as pipe size is increased, and that said pipe is reshaped into an arch shape, having a beginning diameter above 16 feet.

7. The pipe according to claim 6 further comprising that said joined adjacent helical convolutions includes lockseam joining of said ductile material.

8. The pipe according to claim 6 further comprising that said joined adjacent helical convolutions includes welded seam joining of said ductile material.

9. The pipe according to claim 6 further comprising that said joined adjacent helical convolutions includes welded lockseam joining of said ductile material.

10. A horizontally produced spirally formed pipe having a diameter above 16 feet.

11. The pipe according to claim 10 further comprising that said pipe is reshaped into an arch shape.
